(19) United States
(12) Patent Application Publication
(10) Pub. No.: US 2012/0111322 A1
(43) Pub. Date: May 10, 2012

(54) Method and Apparatus for Treatment of Cellulosic Biomass Materials in a Cavitation Reactor

(75) Inventors: Naresh MAHAMUNI, Nevada City, CA (US); Peter L. Nelson, Grass Valley, CA (US)

(73) Assignee: Impulse Devices, Inc., Grass Valley, CA (US)

(21) Appl. No.: 12/942,272

(22) Filed: Nov. 9, 2010

(51) Int. Cl. B01J 19/10; C08B 37/00

(52) U.S. Cl. 127/46.1; 422/127

(57) ABSTRACT

A system and method for treating biomass so as to convert the biomass into a useful form is provided. In some embodiments, the system and method allow treating a biomass mixed in a fluid medium in an acoustic resonator chamber. The chamber may be used to mix the biomass with other chemical agents or catalysts. The chamber is also coupled to one or more acoustical drivers to provide an acoustical (e.g., ultrasonic) field in the chamber, which can also be driven to cause acoustic cavitation in some embodiments. The acoustic resonator chamber may also be placed under static pressure to enhance a mechanical, acoustical, or chemical effect during processing. Various examples of co-processing or pre-processing stages are also provided, including acid, base, AFEX, ammonia and other stages to enhance a desired effect.

### TECHNICAL FIELD

The present application relates to treatment or pre-treatment of certain biomass materials, which can be used in making fuels or fuel precursors, using acoustical energy such as ultrasound. More specifically, aspects of the application are directed to treatment of cellulosic biomass materials using acoustic cavitation in a cavitation chamber containing the same.

### BACKGROUND

Before touching on the inventive aspects in the following sections of this application below, a brief discussion of the subjects of processing biomass material and acoustic reactors is presented.

As to processing of biomass materials: The use of renewable non-edible biomass for manufacture of fuels and chemicals has been proposed for sustainable provision of or contribution to the world's energy needs. Acoustic methods for treating certain materials has been discussed, for example in U.S. Pat. No. 6,333,181, which reports the use of ultrasonic treatment in a simultaneous saccharification and fermentation (SSF) process to enhance the ability of cellulase to hydrolyze mixed office waste paper, thereby reducing the cellulase enzyme requirements.

As to acoustic cavitation: It is known that acoustic fields can be applied to fluids (e.g., liquids, gases) within resonator vessels or chambers. For example, standing waves of an acoustic field can be generated and set up within a resonator containing a fluid medium. The acoustic fields can be described by three-dimensional scalar fields conforming to the driving conditions causing the fields, the geometry of the resonator, the physical nature of the fluid supporting the acoustic pressure oscillations of the field, and other factors.

One common way to achieve an acoustic field within a resonator is to attach acoustic drivers to an external surface of the resonator. The acoustic drivers are typically electrically-driven using acoustic drivers that convert some of the electrical energy provided to the drivers into acoustic energy. The energy conversion employs the transduction properties of the transducer devices in the acoustic drivers. For example, piezo-electric transducers (PZT) having material properties causing a mechanical change in the PZT corresponding to an applied voltage are often used as a building block of electrically-driven acoustic driver devices. Sensors such as hydrophones can be used to measure the acoustic pressure within a liquid, and theoretical and numerical (computer) models can be used to measure or predict the shape and nature of the acoustic field within a resonator chamber.

If the driving energy used to create the acoustic field within the resonator is of sufficient amplitude, and if other fluid and physical conditions permit, cavitation may take place at one or more locations within a liquid contained in an acoustic resonator. During cavitation, vapor bubbles, cavities, or other voids are created at certain locations at times within the liquid where the conditions (e.g., pressure) at said certain locations and times allow for cavitation to take place.

For the sake of illustration, FIG. 1 shows a simplified diagram of an acoustic resonator or cavitation system 10 according to the prior art. A resonator 100 contains a volume of fluid which is to be cavitated. An acoustic driver such as a PZT transducer 110 is fixed to a location on cavitation chamber 100. The coupling is typically done by screw attachment or epoxy attachment of transducer 110 to chamber 100.

Transducer 110 is driven by an electrical driving signal generated by signal generator 120, which provides an output signal that is amplified by amplifier 130. The output of amplifier 130 is coupled to a conducting surface or electrode on transducer 110 to cause the transducer to vibrate, oscillate, or otherwise make an acoustic (e.g., ultrasonic) output. The acoustic output of transducer 110 is then transmitted to chamber 100 due to the acousto-mechanical coupling between transducer 110 and chamber 100.

Under certain conditions, the acoustic action of transducer 110 and chamber 100 set up an acoustic field within the fluid in chamber 100 that is of sufficient strength and configuration to cause acoustic cavitation within a region of chamber 100. Specifically, under suitable conditions, acoustic cavitation of the fluid in chamber 100 may cause bubbles 199 or acoustically-generated voids as described above and known to those skilled in the art, to form within one or more regions of chamber 100. The cavitation usually occurs at zones within the chamber 100 that are subjected to the most intense (highest amplitude) acoustic fields therein.

Acoustic resonator 100 has been designed in a variety of shapes and sizes, and has been used in a variety of applications in the art. For example, resonators made of glass and steel have been devised. Also, resonators having metal walls with glass or quarts optical viewing ports have been devised. Additionally, resonators in the shape of cylinders, spheres, and other shapes have been devised. Furthermore, flow-through resonator systems have been devised, where a flowing fluid passes through the resonator by entering in an inlet fluid port and exiting by an outlet fluid port.

The detailed description below provides numerous embodiments and benefits of applying acoustical energy and cavitation to a suitable material in order to process and transform the same.

### SUMMARY

A system and method for treating biomass so as to convert the biomass into a useful form is provided. In some embodiments, the system and method allow treating a biomass mixed in a fluid medium in an acoustic resonator chamber. The chamber may be used to mix the biomass with other chemical agents or catalysts. The chamber is also coupled to one or more acoustical drivers to provide an acoustical (e.g., ultrasonic) field in the chamber, which can also be driven to cause acoustic cavitation in some embodiments. The acoustic resonator chamber may also be placed under static pressure to enhance a mechanical, acoustical, or chemical effect during processing. Various examples of co-processing or pre-processing stages are also provided, including acid, base, AFEX, ammonia and other stages to enhance a desired effect.

Some embodiments are directed to a system for processing biomass comprising a reactor chamber having rigid walls thereof, a fluid inlet port in said reactor chamber for receiving a fluid or mixture containing said biomass, a fluid outlet port in said reactor chamber for discharging said fluid or mixture once it has been processed in the chamber, and plurality of acoustic drivers coupled to said rigid walls of said chamber for causing an acoustic field within said chamber, said acoustic field being substantially in a portion of said chamber in which said biomass is located.

Other embodiments are directed to a method for substantially converting a biomass from a first form to a second form, comprising receiving said biomass in said first form in combination with a fluid matrix into an inlet port of an acoustic resonator reactor, pressurizing the biomass and the fluid matrix to a given static pressure above atmospheric pressure within said reactor, applying an acoustic field to the pressurized biomass and fluid matrix so as to cause acoustic cavitation in at least a portion of said reactor containing at least some of said biomass, applying mechanical or chemical catalyzing factors to said biomass in said fluid matrix so as to cause conversion of the biomass from said first form to said second form, discharging the biomass in said second form and said fluid matrix from an outlet port of said reactor, and recovering the biomass in its second form.

### BRIEF DESCRIPTION OF THE DRAWINGS

For a fuller understanding of the nature and advantages of the present concepts, reference is be made to the following detailed description of preferred embodiments and in connection with the accompanying drawings, in which:

FIG. 1 illustrates a simple acoustic resonator;

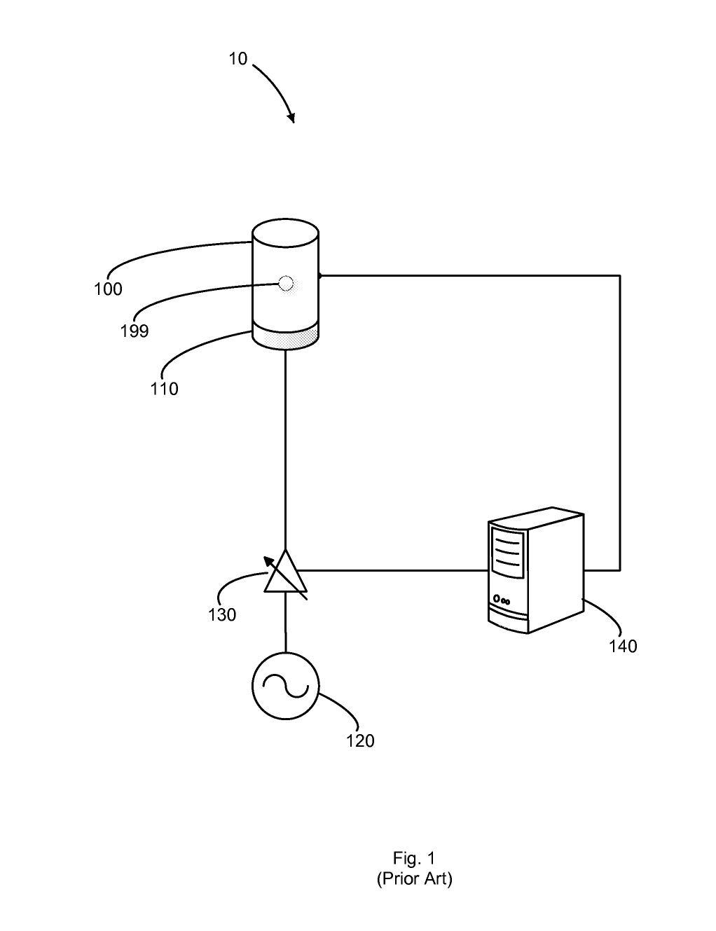

FIG. 2 illustrates a fluid and acoustic circuit for delivering fluid media into an acoustic resonator under pressure;

FIG. 3 illustrates a cross-section of an exemplary acoustic resonator capable of causing cavitation in a fluid medium therein;

FIG. 4 illustrates an exemplary structure of biomass;

FIG. 5 illustrates processing effects on a biomass;

FIG. 6 illustrates a system and process for treating biomass in a reactor; and

FIG. 7 illustrates a multi-stage process and system for treating biomass.

### DETAILED DESCRIPTION

It has been recognized by the present inventors that some useful effects can be achieved by appropriate sonication and treatment of cellulosic materials, which can be beneficial in industrial, chemical, manufacturing, fuel processing or pre-processing, and other applications. Accordingly, novel methods for processing and/or treating such materials using acoustical energy have been investigated and developed, and effective new treatment and processing systems have been designed for such uses as described below.

In some embodiments, an acoustical resonator is used to process the cellulosic materials, which can be provided to the resonator in a fluid mixture or suspension or slurry as appropriate. The fluid may be used to communicate acoustical (e.g., ultrasonic) energy from acoustical sources coupled to said resonator to the cellulosic material. The fluid may also be used to chemically treat or catalyze a reaction or effect on said cellulosic material as well as to entrain and move a stream of said cellulosic material into and out of the reactor or resonator chamber at a given rate.

In some embodiments, the acoustical resonator reactor may be pressurized by a static fluid pressure source so that the effect on the cellulosic material is enhanced. For example, driving the acoustical (ultrasonic) sources at a sufficiently great amplitude to cause cavitation within the resonator may be enhanced by application of a baseline static pressure within the reactor chamber. Such effects described in applications by the present assignee and applicants, referenced and incorporated herein, may cause increased cavitation activity that in turn may cause enhanced processing effects on the cellulosic material. It is to be understood that enzymes, chemical catalysts, acids, salts, bases, reagents of various kinds, and other organic or chemical agents and additives may be included at some or all stages of the present processing to enhance the end effect or to cause a desired outcome.

In some particular situations, it is desirable to process (or pre-process, herein generally “process”) a cellulosic or lignocellulosic material with the goal of producing ethanol therefrom. Ethanol is useful as a fuel or a component in the production of fuel for internal combustion engines and other uses. Present methods for processing lignocellulosic material for ethanol production rely on the use of expensive and wasteful enzymes and other chemical agents as will be discussed below.

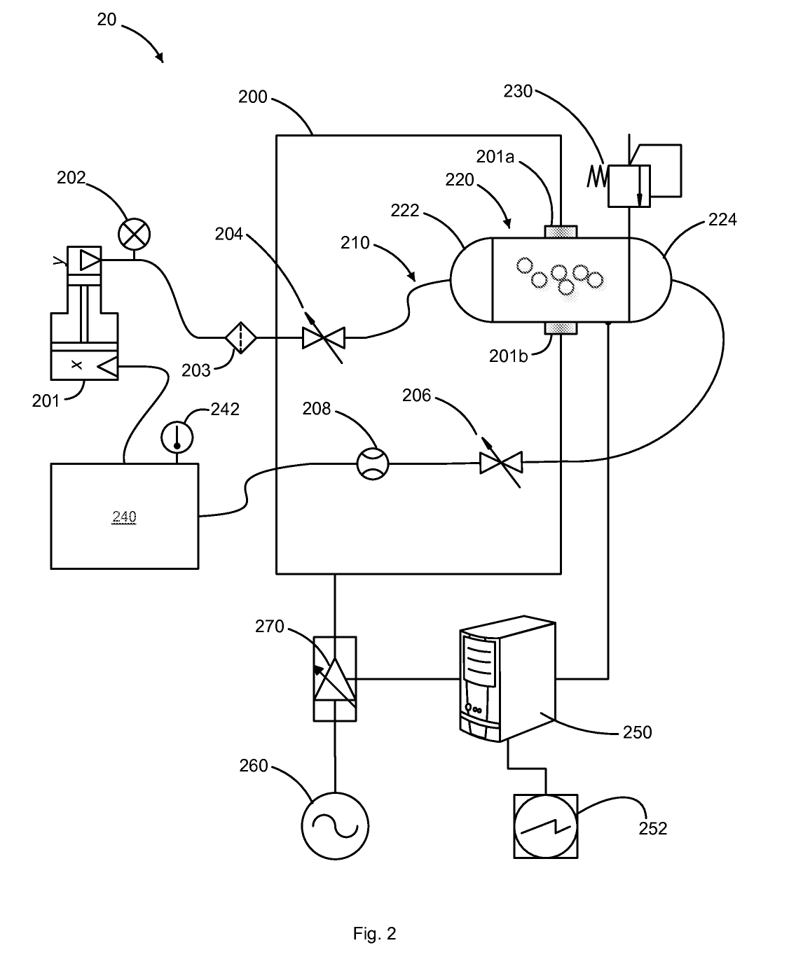

FIG. 2 illustrates an exemplary fluid circuit that can be used to process a fluid containing biomass. The system 20 includes an electrical circuit 200 for driving the acoustic drivers 201a and 201b (which can be generalized to a plurality of acoustic drivers). The circuit is controlled by a controller or control processor or control computer 250. A signal generator or waveform generator 260 provides a signal that is amplified by amplifier 270, which is in turn computer-controlled by computer or processor 250. As mentioned earlier, the driving output of amplifier 270 provides the electrical stimulus to cause transduction within transducers 201a, b, which in turn cause acoustical field generation within resonator chamber 220.

The heavier lines of FIG. 2 represent a fluid circuit that circulates a fluid to be acoustically cavitated in resonator or chamber 220. The resonator 220 comprises a first end cap or end bell 222 at a first end thereof, and a second end cap or end bell 224 at a second end thereof. Said first and second ends of resonator 220 being substantially at opposite ends of said resonator 220 in some embodiments. Generally, a fluid is flowed in resonator 220, sometimes under static pressure, and said fluid may be cavitated by acoustic transducers 201a, b. As will be described further, the relative placement of the transducers and the fluid inlet and outlet ports in the system with respect to the acoustic field within the resonator 220 is arranged to achieve a desired outcome in processing the flowing pressurized fluid and/or materials suspended or dissolved therein.

The fluid circuit includes a fluid driver (e.g., a pump such as a rotary or reciprocating pump) 201. The pump 201 drives the fluid against the head loss in the fluid circuit portion of cavitation system 20. A pressure gauge 202 may be installed at a useful location downstream of pump 201 to monitor the pressure at its highest value downstream of pump 201. A filter 203 may be used inline with the flowing fluid to trap any impurities or dirt in the fluid.

A solenoid or gate valve 204 may be used to secure the fluid flow in some cases or to isolate the resonator upstream of the resonator 220. A second solenoid valve 206 is used to secure flow of the fluid or to isolate the resonator 220 in cooperation with valve 204.

Relief value 230 may be provided as a safety mechanism to relieve fluid from the system if the pressure of said fluid exceeds a pre-determined threshold. For example, the relief valve may be set to discharge fluid in a controlled way if the pressure within resonator 220 approaches a value that could jeopardize the integrity of the resonator or other system components.

Fluid flow rate meter 208 may be used to sense and provide an indication of the rate of fluid flow (e.g., in cubic centimeters per second) through the fluid system. Because the fluid is generally incompressible, the fluid flow rate in the outlet portion of the system (as pictured) is substantially the same as the flow rate at the inlet to resonator 220.

A fluid holding, storage, surge or expansion tank or reservoir 240 is provided to contain an adequate amount of fluid and mediate any volumetric or pressure surges in the system. A temperature sensor (thermometer) 242 is used to provide an indication of the temperature of the fluid in the system.

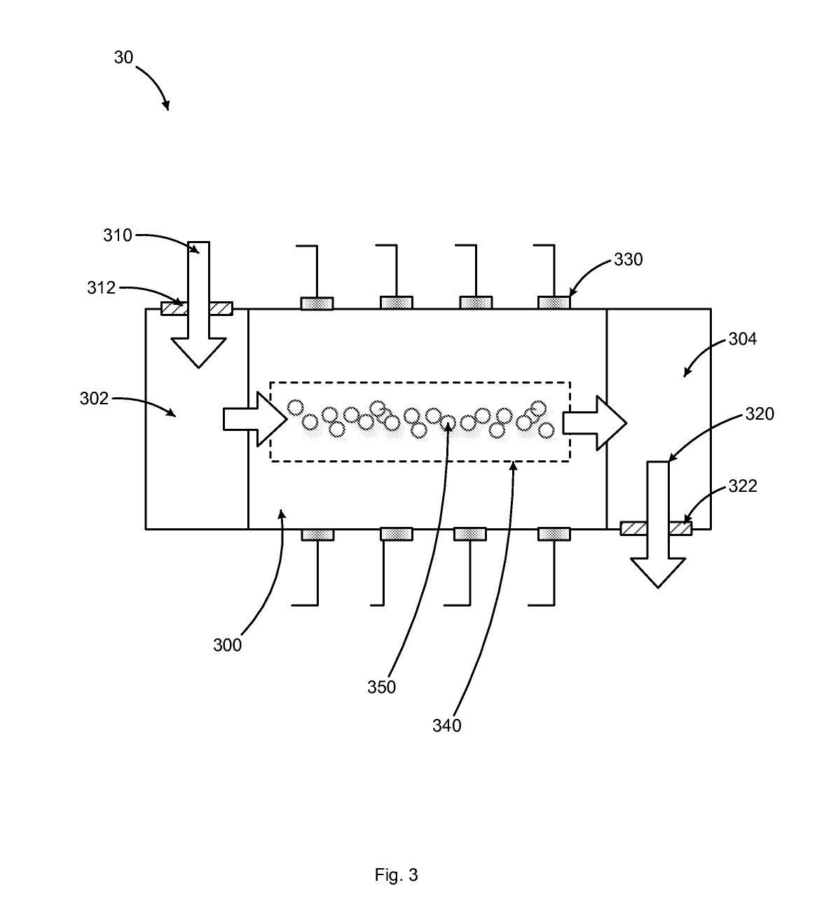

FIG. 3 illustrates a cross sectional view of a chamber 30 that could be used with the present systems and methods to acoustically process a fluid containing biomass, for example in causing acoustic cavitation in a volume within the chamber 30. The chamber 30 includes a main cavitation volume 300 having inlet and outlet volumes 302 and 304 respectively. The incoming fluid and biomass 310 are received through inlet port 312 and the exiting fluid and processed biomass 320 exit through discharge port 322. The flow of fluid in chamber 30 is therefore generally from left to right in FIG. 3. Note that in the present embodiment, the fluid ports 312 and 322 are not disposed in the respective end walls of their inlet and outlet volumes 302 and 304. Instead, the fluid ports 312 and 322 are disposed in a side wall of volumes 302 and 304 respectively. However, many other configurations of chamber 30 are possible, and reference is made to co-pending application Atty. Docket No. IDI.USPAT.0400, which illustrates several examples of the same. Here, cavitation primarily takes place in a cavitation zone 340 that then develops cavitation bubbles 350. The biomass in the fluid is altered and affected by the cavitation and acoustical action on the fluid and the biomass therein.

A positive pressure may be applied to the cavitation system 30 by pressurizing the fluid system, e.g., by using a pump as shown earlier in FIG. 2. In this embodiment, the flow generally moves parallel to (along) the long axis of symmetry of the cavitation chamber.

In order to achieve cost effective production of ethanol from lignocellulosic materials it is desirable to minimize or reduce the use of enzymes, the use of said enzymes presenting a substantial cost and technical challenge in existing processes for ethanol production. The present concepts provide for new ways of processing cellulosic and biomass materials so as to transform them into more useful forms that could be used for making fuel and fuel precursor substances.

In some aspects, an acoustic processing chamber or reactor, which may further provide acoustic cavitation therein, is used to process the biomass materials. In other aspects, fluid and slurry mixtures of biomass materials may be mixed with other fluids or chemicals, enzymes, catalysts, and the like within said acoustic reactor chambers. High static pressures may be applied to the contents of the reactors during processing in some aspects. The result is a material that is processed or pre-processed for producing fuel ingredients and other useful substances. Examples of reactor chambers that provide pressure, fluid flow and acoustic cavitation conditions are described in co-pending patent application bearing Attorney Docket No. IDI.USPAT.0400, which is assigned to the present assignee and which is hereby incorporated by reference in its entirety.

Cellulosic biomass, sometimes called lignocellulosic biomass, is a heterogeneous complex of carbohydrate polymers (cellulose and hemicellulose) and lignin, a complex polymer of phenylpropanoid units. Biomass includes substantial amounts of cellulose (30-50%), hemicellulose (10-35%) and lignin (5-30%). Cellulose and hemicellulose are useful for conversion into C5 and C6 sugars which can further be converted to either fuels such as bioethanol or chemicals such as furfural, HMF, leuvinic acid, and lignin can be thermochemically depolymerised to platform chemicals such as phenolics and styrene. In addition to ethanol, many more chemicals and chemical feedstocks are potential products from renewable plant biomass.

Table I, below shows exemplary composition of typical biomass feedstocks in terms of their main components, (see, Mosier et al., Features of promising technologies for pretreatment of lignocellulosic biomass, Bioresource Technology Vol. 96, No. 6, April 2005, pp. 673-686, which is hereby incorporated by reference). The figures below generally do not add up to 100%, as minor components are not listed.

TABLE I
Composition of Typical Feedstock Biomass
Percent dry weight composition of lignocellulosic feedstocks

| | Glucan | Xylan | |
|---|---|---|---|
| Feedstock | (cellulose) | (hemicellulose) | Lignin |
| Corn Stover | 37.5 | 22.4 | 17.6 |
| Corn fiber | 14.28 | 16.8 | 8.4 |
| Pine wood | 46.4 | 8.8 | 29.4 |
| Popular | 49.9 | 17.4 | 18.1 |
| Wheat straw | 38.2 | 21.2 | 23.4 |
| Switch grass | 31.0 | 20.4 | 17.6 |
| Office paper | 68.6 | 12.4 | 11.3 |
| Hardwood stems | 40-55 | 24-40 | 18-25 |
| Softwood stems | 45-50 | 25-35 | 25-35 |
| Nut shells | 25-30 | 25-30 | 30-40 |
| Corn cobs | 45 | 35 | 15 |
| Grasses | 25-40 | 35-50 | 10-30 |
| Paper | 85-99 | 0 | 0-15 |
| Sorted refuse | 60 | 20 | 20 |
| Leaves | 15-20 | 80-85 | 0 |
| Cotton seed hairs | 80-95 | 5-20 | 0 |
| Newspaper | 40-55 | 25-40 | 18-30 |
| Waste papers from | 60-70 | 10-20 | 5-10 |
| chemical pulps | | | |
| Solid cattle manure | 1.6-4.7 | 1.4-3.3 | 2.7-5.7 |
| Coastal | 25 | 35.7 | 6.4 |
| bermudagrass | | | |
| Swine waste | 6.0 | 28 | na |

Cellulose is a linear homopolysaccharide that consists of glucose (D-glucopyranose) units linked together by β-(1-4) glycosidic bonds (β-D-glucan). This polysaccharide is widespread in nature, occurring in both primitive and highly evolved plants. The size of a cellulose molecule is normally given in terms of its degree of polymerization (DP), i.e., the number of anhydroglucose units present in a single chain. However, the conformational analysis of cellulose indicates that cellobiose (4-O-β-D-glucopyranosyl-β-D-glucopyranose) may comprise its basic structural unit.

In some instances the cellulose backbone is substantially linear in structure, and therefore, adjacent chains form a framework of water-insoluble aggregates of varying length and width and these elementary fibrils contain both ordered (crystalline) and less ordered (amorphous) regions. Lattice forces that are responsible for maintaining the crystalline regions are basically the result of extensive inter- and intramolecular hydrogen bonding. Several elementary fibrils with an average thickness of, e.g., 3.5 nm may associate with one another to form cellulose crystallites whose dimensions depend on the origin and treatment of the sample. Several (e.g., four) of these basic crystalline aggregates are then held together by a monolayer of hemicelluloses, generating, e.g., 25 nm wide thread-like structures that are enclosed in a matrix of hemicellulose and protolignin. The natural composite that results from this close association is referred to as cellulose microfibril.

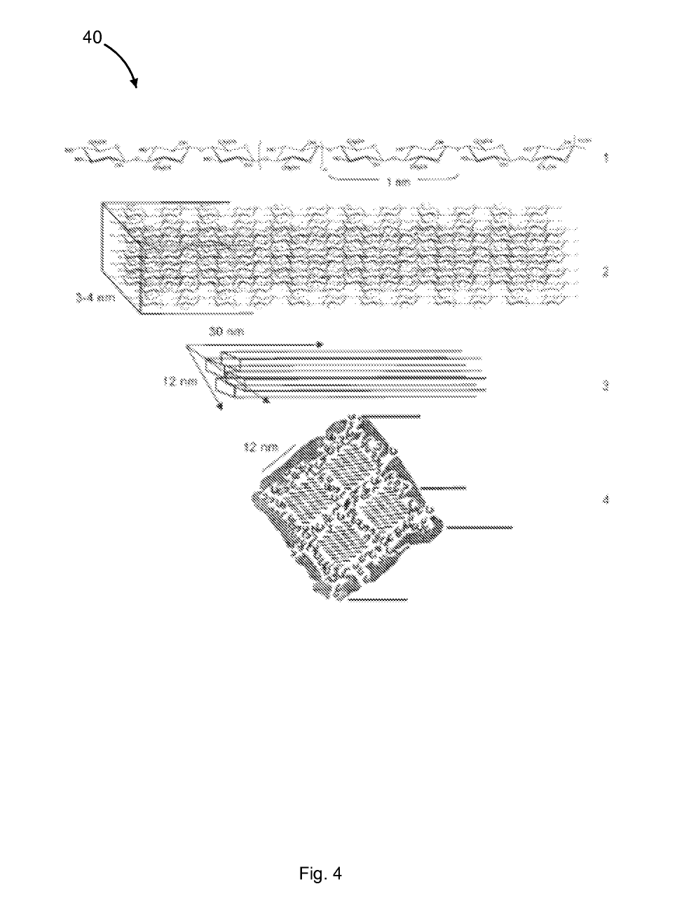

FIG. 4 illustrates the above structural features 40 graphically, and is not provided to scale or by way of limitation. Also, the present example and dimensions are of course merely illustrative, and those skilled in the art would appreciate the applicability of the present disclosure to other examples.

Hemicelluloses are plant heteropolysaccharides whose chemical nature varies from tissue to tissue and from species to species. These polysaccharides are formed by a wide variety of building blocks including pentoses (e.g., xylose, rhamnose and arabinose), hexoses (e.g., glucose, mannose and galactose) and uronic acids (e.g., 4-Omethyl-glucuronic and galacturonic acids). Generally, these fall into four classes: (a) unbranched chains such as (1-4)-linked xylans or mannans; (b) helical chains such as (1-3)-linked xylans; (c) branched chains such as (1-4)-linked galactoglucomannans; and (d) pectic substances such as polyrhamnogalacturonans. Some hemicelluloses, particularly heteroxylans, also show a considerable degree of acetylation. Hemicelluloses are structurally more related to cellulose than lignin and are deposited in the cell wall at an earlier stage of biosynthesis. Despite the complexity of these polysaccharides, their structure seems to be generally rod-shaped with branches and side chains folded back to the main chain by means of hydrogen bonding. This rodlike structure facilitates their interaction with cellulose, resulting in a tight association that gives great stability to the aggregate. The hemicellulose content of softwoods and hardwoods differ significantly. Hardwood hemicelluloses are mostly composed of highly acetylated heteroxylans, generally classified as 4-O-methyl glucuronoxylans. Hexosans are also present but in very low amounts as glucomannans. Owing to their acidic characteristics and chemical properties, hardwood xylans are relatively labile to acid hydrolysis and may undergo auto-hydrolysis under relatively mild conditions. In contrast, softwoods have a higher proportion of partly acetylated glucomannans and galactoglucomannans, and xylans correspond to only a small fraction of their total hemicellulose content. As a result, softwood hemicelluloses (mostly hexosans) are more resistant to acid hydrolysis than hardwood hemicelluloses (mostly pentosans). In plant tissues, hemicelluloses are generally combined with lignin.

Lignin is a phenolic macromolecule that is primarily formed by the free-radical polymerisation of p-hydroxy cinnamyl alcohol units with varying methoxyl contents. The chemical structure of lignin may be based on three monomeric precursors: coniferyl alcohol, sinapyl alcohol, and p-coumaryl alcohol. The proportion of these monomers varies among species and this ratio has been used for taxonomic purposes. Depending on the degree of methoxylation, the aromatic group is p-hydroxybenzyl (derived from p-coumaryl alcohol), guaiacyl (derived from coniferyl alcohol) or syringyl (derived from sinapyl alcohol). The former is not methoxylated, whereas the latter two have one or two methoxyl groups adjacent to the phenolic hydroxyl group, respectively. One physical property of this organic macromolecule is its rigidity, which not only gives strength to the plant tissue but also prevents the collapse of the water-conducting elements. Softwood lignins are almost exclusively composed of residues derived from coniferyl alcohol (lignin type G), whereas hardwood lignins contain residues derived from both coniferyl and sinapyl alcohols (lignin type GS). In contrast, lignins derived from grasses and herbaceous crops contain the three basic precursors (lignin type HGS). As a consequence, hardwood lignins may have a higher methoxyl content, and be less condensed and be more amenable to chemical conversion than lignins derived from conifers/softwood. In other cases, hardwood vessels may contain a lignin component that is more structurally related to the guaiacyl lignin type of softwoods. These structural differences among various biomass feedstocks such as softwoods, hardwoods and herbaceous crops and grasses are responsible for the lack of a single universal pretreatment process for all kinds of biomass feedstocks. The present discussion being by way of increased specificity, and those skilled in the art being understood to appreciate the general nature of the compositions and extensions of the present examples.

It may be desirable in utilization of lignocellulose for ethanol/chemicals production to efficiently yield a fermentable hydrolyzate rich in sugars (from the carbohydrate content present in the feedstock). Employment of enzymes for the hydrolysis of lignocellulose is one strategy for achieving this to obtain higher yields, minimal byproduct formation, low energy requirements, mild operating conditions, and environmentally friendly processing. However, the enzymatic digestibility of native cellulose in biomass is usually less than 20% without pretreatment. Hence pretreatment of some form is useful, in some or all embodiments, to achieve meaningful conversions. The conversion of biomass to useful chemicals or fuels may comprise several steps, including in some embodiments: 1. Feedstock Preparation, 2. Biomass Pretreatment, 3. Enzyme Hydrolysis, 4. Ethanol Fermentation and 5. Product Separation/Purification.

Lignin and hemicellulose together form a protective layer around cellulose to make it inaccessible for attack by microbes and bacteria and thus provide the strength to support the trees and plants. Factors such as the crystallinity of cellulose, accessible surface area, protection of cellulose by lignin, the heterogeneous character of biomass particles, degree of hemicellulose acetylation and cellulose sheathing by hemicellulosel contribute to the recalcitrance of lignocellulosic biomass to hydrolysis.

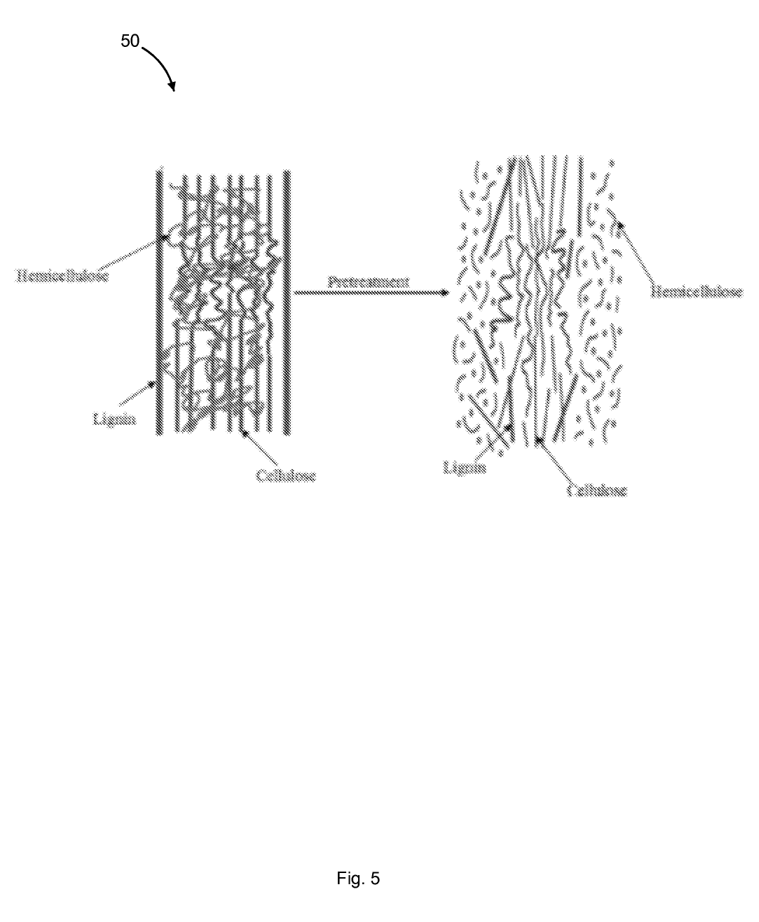

Pretreatment is usually an important and costly step for practical cellulose conversion processes. Pretreatment is therefore often performed in order to alter the structure of cellulosic biomass to make cellulose/hemicelluloase more accessible to the enzymes that convert the carbohydrate polymers into fermentable sugars as illustrated in FIG. 5. In some embodiments, a goal of pretreatment is to break the lignin seal and make available hemicellulose and cellulose for enzymatic hydrolysis and also disrupt the crystalline structure of cellulose. Pretreatment is conventionally an expensive processing step in cellulosic biomass-to-fermentable sugars conversion with costs that can exceed 30¢/gallon of ethanol produced. The present solutions provide ways for reducing the cost of pretreatment or processing of the cellulosic materials in ethanol production in some or all aspects hereof.

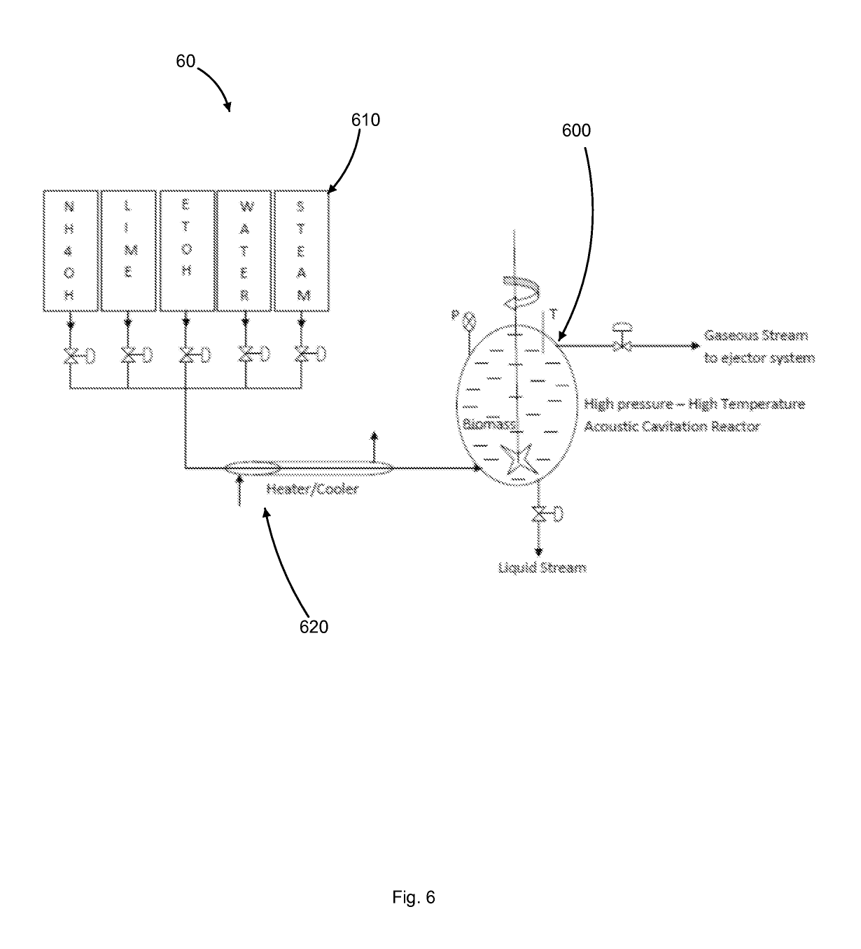

FIG. 6 illustrates an exemplary system 60 and technique for processing a biomass in a reactor 600 as discussed herein. The reactor 600 may, as stated above, include acoustical drivers (shown in other drawings) to provide an acoustic energy field (e.g., standing wave or other field) within the reactor 600. Various agents and chemical additives and catalysts 610 may be provided, alone or in combination, to enable the best process for a given context. In addition, process temperature control may be provided by cooling or heating elements 620, e.g., heat exchangers.

Pretreatment methods may be physical or chemical in nature, as mentioned above, and some embodiments may incorporate both effects. Specifically, some pretreatment methods comprise comminution (dry, wet, and vibratory ball milling and compression milling etc.), steam explosion, hydrothermolysis (liquid hot water), use of dilute acids and bases such as H₂SO₄ and NaOH treatment, use of alkaline H₂O₂, ozone treatment, organosolv treatment (uses Lewis acids, FeCl₃, (Al)₂SO₄ in aqueous alcohols and solvents such as glycerol, dioxane, phenol, or ethylene glycol). Treatments using concentrated mineral acids (H₂SO₄, HCI), ammonia-based solvents (NH₃, hydrazine), aprotic solvents (DMSO), metal complexes (ferric sodium tartrate, cadoxen, and cuoxan), and wet oxidation have also been used as pretreatment techniques as they can reduce the cellulose crystallinity as well as disrupt the chemical bonds between lignin, hemicellulose and cellulose. Other pretreatment processes are possible and may be combined with processes known to those skilled in the art without loss of generality.

In some aspects, the present systems and methods provide a substantially universal way to treat an almost arbitrary type of biomass and hence will have more commercial value than those presently available or known in the field. Various aspects hereof provide pretreatment techniques that substantially increase or maximize the recovery of available carbohydrates such as cellulose and hemicellulose while substantially reducing or minimizing the degradation of sugars and the generation of possible inhibitors and should be minimizing energy input, and are comparatively cost-effective.

In one embodiment, an organosolv treatment followed by lime treatment followed by AFEX treatment/use of ammonia in the form of ammonium hydroxide is employed. The use of organosolv may allow removal of extractible materials such as pectins, gums, oils etc present in the ground biomass before it actually goes to the chemical pretreatment. Lime treatment will be used to convert the high lignin biomass (>15-20%) into low lignin biomass (<15%) and AFEX will be used for the treatment of low lignin biomass (<15-20%). In some embodiments, these processes will be carried out in a pressurized acoustic resonator or cavitation chamber as described above and in other patents and patent applications by the present applicants and assignee.

In some embodiments, the processing comprises a step of aqueous ethanol polishing. This may employ an aqueous ethanol polishing to remove extractible components of the ground biomass before it can be sent for a series of pretreatments. This may help remove constituents such as pectins, proteins and extractives (soluble nonstructural materials such as nonstructural sugars, nitrogenous material, chlorophyll, and waxes) which are present in the lignocellulosic biomass in smaller amounts apart from three main constituents such as cellulose, hemicellulose and lignin. This may also reduce the chances of formation of toxic inhibitors.

In other embodiments, the processing may comprise lime or other alkaline treatment. This is a kind of alkali treatment which utilize lower temperatures and pressures compared to other pretreatment technologies. Alkaline pretreatment is substantially a delignification process, in which a significant amount of hemicellulose may be solubilized as well. The action/mechanism may provide saponification of intermolecular ester bonds crosslinking xylan hemicelluloses and other components, for example, lignin and other hemicellulose. In some aspects, the porosity of the lignocellulosic materials increases with the removal of these crosslinks. Alkaline pretreatment may also remove acetyl and various uronic acid substitutions on hemicellulose that reduce the accessibility of hemicellulose and cellulose to enzymes. In addition, alkaline pretreatment of lignocellulosic materials may cause swelling, leading to decreased degree of polymerization (DP) and crystallinity, increased internal surface area, disruption of the lignin structure, and separation of structural linkages between lignin and carbohydrates.

The effectiveness of alkaline pretreatment can vary, depending on the substrate and treatment conditions. In general, alkaline pretreatment is more effective on hardwood, herbaceous crops, and agricultural residues with low lignin content than on softwood with high lignin content. Alkali pretreatment may be carried out at ambient conditions, but pretreatment time is measured in terms of hours or days rather than minutes or seconds. Acoustic energy, for example acoustic cavitation, and in other examples cavitation under static pressure conditons may enhance the action of the alkaline treatment in some embodiments. In general, alkaline hydrolysis is more effective at delignification of lignocellulose sources with lower lignin contents and the remaining cellulose has a higher reactivity and is more susceptible to enzyme attack. In some embodiments, the hemicellulose may not be hydrolysed but is left as an insoluble polymer. For example, lime may be used to pretreat wheat straw, poplar wood, switchgrass and corn stover/corncobs in the past to improve the enzyme digestibility of the cellulose. Exemplary amounts employed for lime pretreatment are ˜0.1 gram lime per gram of biomass and 5 grams or more of water per gram of biomass may be used.

Thermal treatment can also be used in some embodiments, separate from or concurrent with the other treatment steps described herein. For example, the treatment can be conducted at temperatures from 25-130° C., with higher temperatures generally speeding the reactions. The heating may be achieved using electric heating elements within the reaction chamber, or by pre-heating the fluid in which the cellulosic material is presented, for example using a water heater or steam heating or other heating source such as a radiant or convection heat exchanger.

During lime treatment around one third of the lignin content may be removed as well the acetyl groups present on the hemicellulose. Lime (calcium hydroxide) has the additional benefits of low reagent cost and safety and is easily recoverable from water as insoluble calcium carbonate by reaction with carbon dioxide. The carbonate can then be converted to lime using established lime-kiln technology and thus can be recycled again and again. The addition of air/oxygen to the reaction mixture greatly improves the delignification of the biomass, especially highly lignified materials such as poplar tree biomass.

In some embodiments, given here by way of illustration, the oxidative lime pretreatment of poplar at about 150° C. for about 6 hours may remove over 75% of the lignin from the wood chips and improve the yield of glucose from enzymatic hydrolysis from 7% (untreated) to 77% (treated) compared to the untreated and pretreated poplar wood.

In other embodiments, lime may be used to pretreat corn stover to obtain substantial lignin removal of over 85% at about 55° C. in a few (e.g., four) weeks with aeration of the same. The process of lime pretreatment involves slurrying the lime with water, spraying it onto the biomass material, and storing the material in a pile for a period of hours to weeks. The particle size of the biomass is typically 10 mm or less, but can be another size depending on the application. As mentioned above, elevated temperatures (e.g., 85-100° C.) and/or pressures may further reduce the contact time required. Alkali pretreatment technologies, including lime pretreatment, are rather similar to the Kraft paper pulping technology.

One useful effect of the alkaline pretreatment is the removal of lignin from the biomass, thus improving the reactivity of the remaining polysaccharides. In addition, alkali pretreatments remove acetyl and the various uronic acid substitutions on hemicellulose (these linkages lower the accessibility of the enzyme to the hemicellulose and cellulose surface). The addition of air/oxygen may also provide a favorable effect in case of low lignin biomass (e.g., below 15%) according to some embodiments.

Some embodiments include a step of ammonia treatment. Ammonia has been used in different forms such as anhydrous ammonia either in gaseous or liquid form under pressure or in the form of aqueous dissolved form (ammonium hydroxide of various concentration). Here it may be applied in either continuous mode such as flow through reactors (called ammonia percolation and recycle, APR) or batch mode (called soaking in aqueous ammonia, SAA). However, continuous flow model is generally preferred as it avoids the re-deposition of removed lignin or other degradation products on to biomass which may inhibit the enzymatic activity by blocking active sites of cellulose as well as reduce the useful amount of enzyme by binding some amount of enzyme on it. Liquid ammonia causes cellulose swelling and a phase change in the crystal structure from cellulose Ito cellulose III which may improve the reactivity of cellulose. Penetration of liquid NH₃ into lignocellulosic matrix may be rapid due to the lower viscosity and surface tension of liquid ammonia relative to liquid water. Also, the ammonia may also react with lignocellulosics by ammonolysis of the ester crosslinks of some uronic acids with the xylan units and cleaving the bond linkages between hemicellulose and lignin.

In other embodiments, AFEX (ammonia fiber expansin) is used in which anhydrous liquid ammonia is reacted with biomass under very high pressure and temperature and the pressure is released immediately after a particular reaction time so that explosive decompression of lignocellulosic biomass takes place. AFEX is conceptually similar to the steam explosion. This swift reduction of pressure opens up the structure of lignocellulosic biomass leading to increased digestibility of biomass. By way of example, the density of alfalfa biomass may decrease, e.g., from 290 kg/m³ to 180 kg/m³ following AFEX treatment and the water holding capacity of the treated biomass may increase by e.g. 50%.

AFEX pretreatment may substantially simultaneously delignify and solubilize some hemicellulose while decrystallizing cellulose, but may not significantly remove hemicellulose as acid and acid-catalyzed steam-explosion pretreatment does. Under these conditions, aqueous ammonia may react primarily with lignin (but sometimes not with cellulose) and cause depolymerization of lignin and cleavage of lignin-carbohydrate linkages.

In some instances, the AFEX process may be controlled to achieve a large and adjustable degree of delignification by controlling various parameters such as residence time, temperature, ammonia concentration and percent biomass loading. Also, ammonia treatment can be effectively used on coarsely chipped biomass, although fine grinding prior to enzymatic hydrolysis would be helpful to achieve good enzymatic hydrolysis yields. As removal of lignin lowers the enzyme requirement for cellulose hydrolysis, AFEX may help reduce the cost of biomass conversion and may reduce the amount of unwanted waste products from treatment of the same. Thus, both micro- and macro-accessibilities of cellulose to the cellulase are affected in AFEX pretreatment. Because ammonolysis reactions do not produce major inhibitors (e.g., organic acids) for enzymes and microbes, it is possible to ferment and hydrolyze the substrate without detoxification in some cases. It should be noted that AFEX treated biomass may require the utilization of hemicellulose hydrolytic enzymes in addition to cellulases to produce fermentable sugars. Typically, AFEX operating conditions can include aqueous ammonia dosage (about 0.3-2.0 kg ammonia/kg dry biomass), temperature (about 90° C.), pH values (about 12.0), and pretreatment time (about 30 min). The composition of the AFEX pretreated materials is essentially the same as the original in some cases; however, the digestibility of the biomass may be thereby improved.

AFEX can be applied to various lignocellulosic materials, including rice straw, municipal solid waste, newspaper, sugar beet pulp, sugar cane bagasse, corn stover, switchgrass, miscanthus, aspen chips, etc. Herbaceous crops and agricultural residues are also well suited for AFEX. AFEX may be moderately effective for use with biomasses having high lignin content such as hardwood, softwood and newspaper, but various present embodiments improve this effectiveness, for example by using other processes including acoustic and/or pressure and/or thermal treatment (and a combination thereof). These processes may achieve yields of enzymatic hydrolysis of AFEX-pretreated newspaper (18%-30% lignin) and aspen chips (25% lignin) greater than 40% or 50% respectively using the present systems and methods.

The AFEX process, especially when combined with the present techniques in an acoustic reactor include: (1) producing little or negligible inhibitors for the downstream biological processes, so water wash may not be necessary; and (2) requiring little or substantially no particle size reduction. In some embodiments, ammonia may be recycled after the AFEX pretreatment based on the considerations of both the ammonia cost and environmental protection. The volatility of ammonia allows it to be recovered and reused, leaving the dried biomass ready for enzymatic hydrolysis. Also, chemically combined nitrogen (via amide formation) or residual ammonia/ammonium increases overall nitrogen content, and thus may improve the value of NH₃ treated biomass as feeds for ruminants. AFEX may also result in reductions in minimum ethanol selling price, which is of benefit to manufacturers and retailers of these materials as well as beneficial to the end users thereof.

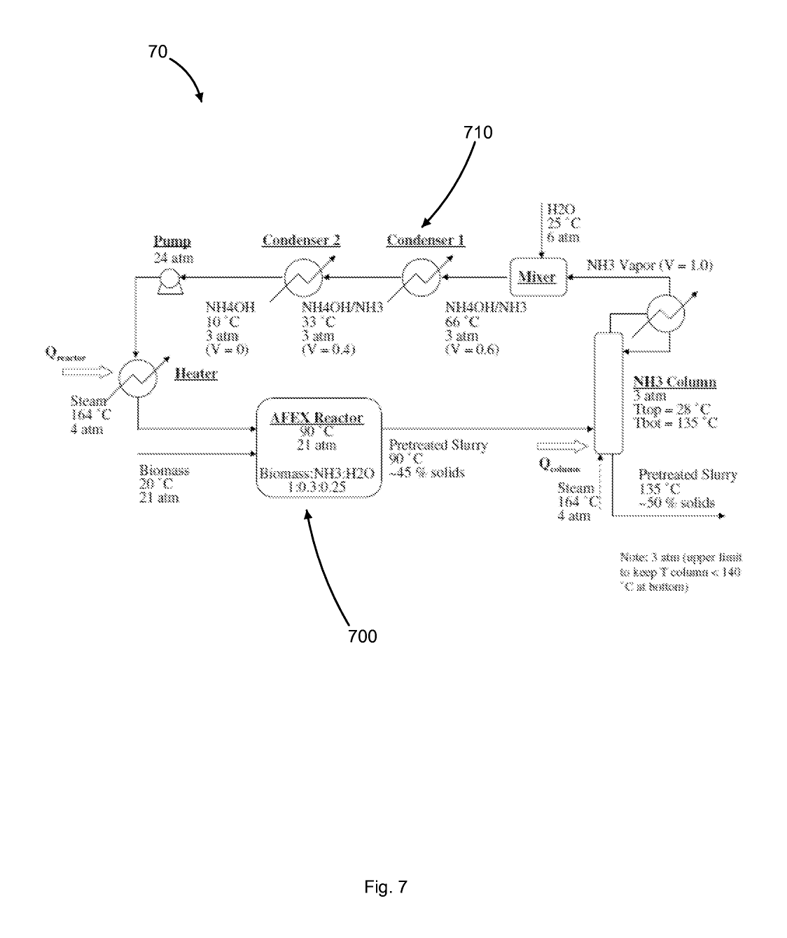

FIG. 7 illustrates an exemplary system 70 and process for the pretreatment stage of a biorefinery using a quench ammonia recovery process. An AFEX reactor 700 is provided for taking in the biomass of interest, and can be equipped with pressure source or acoustic drivers as described earlier. Ammonia recovery stages 710 are also illustrated in the exemplary and simplified system 700. In some embodiments, optimum sugar yields (greater than about 90%) uses about 30%-80% ammonium hydroxide in the process.

Accordingly, various embodiments of the present systems and methods provide for the use of acoustic cavitation carried out under static (sometimes high) pressure in an apparatus permitting fluids and other materials to be flowed therethrough, combining chemical and ultrasonic effects to process such fluids and materials in an acoustic reactor resonator, and the resultant conversion of materials into a more desired form. For example, the conversion of carbohydrates, e.g., hemicelluloses and celluloses, into glucose by depolymerization of the bigger bio-macro-molecules using acoustic shock waves and other cavitation effects such as streaming, micro-jet effects and mixing.

The present invention should not be considered limited to the particular embodiments described above, but rather should be understood to cover all aspects of the invention as fairly set out in the attached claims. Various modifications, equivalent processes, as well as numerous structures to which the present invention may be applicable, will be readily apparent to those skilled in the art to which the present invention is directed upon review of the present disclosure. The claims are intended to cover such modifications.

We claim:

1. A system for processing biomass, comprising:
a reactor chamber having rigid walls thereof and adapted for operation under a net positive static pressure;
a fluid inlet port in said reactor chamber for receiving a fluid or mixture containing said biomass;
a fluid outlet port in said reactor chamber for discharging said fluid or mixture once it has been processed in the chamber;
a plurality of acoustic drivers coupled to said rigid walls of said chamber for causing an acoustic field within said chamber in at least an area of said chamber under a net positive static pressure, said acoustic field being substantially in a portion of said chamber in which said biomass is located.

2. The system of claim 1, further having acoustic drivers that are configured and arranged to cause acoustic cavitation within a fluid within said chamber, and said cavitation and chamber adapted to act on said biomass to affect a desired result in a portion of said biomass, such as lignin.

3. The system of claim 1, further comprising a pump for moving said fluid or mixture through said system.

4. The system of claim 1, further comprising a pressurizer for applying a static pressure in said chamber.

5. The system of claim 4, said pressurizer comprising a pump that pumps up said fluid or mixture to a given static pressure.

6. The system of claim 4, said pressurizer comprising a gas loading vessel for pressurizing said fluid or mixture to a given static pressure.

7. The system of claim 1, further comprising at least one chemical pretreatment stage for applying a chemical agent to said biomass during processing.

8. The system of claim 7, said pretreatment stage comprising ammonia treatment.

9. The system of claim 7, said pretreatment stage comprising an acid treatment stage.

10. The system of claim 7, said pretreatment stage comprising a base treatment stage.

11. The system of claim 1, further comprising an AFEX treatment stage.

12. The system of claim 1, further comprising a temperature control stage, which may comprise a heating and/or a cooling stage.

13. A method for substantially converting a biomass from a first form to a second form, comprising:
receiving said biomass in said first form in combination with a fluid matrix into an inlet port of an acoustic resonator reactor;
pressurizing the biomass and the fluid matrix to a given static pressure above atmospheric pressure within said reactor;
applying an acoustic field to the pressurized biomass and fluid matrix so as to cause acoustic cavitation in at least a portion of said reactor containing at least some of said biomass;
applying mechanical or chemical catalyzing factors to said biomass in said fluid matrix so as to cause conversion of the biomass from said first form to said second form;
discharging the biomass in said second form and said fluid matrix from an outlet port of said reactor; and
recovering the biomass in its second form.

14. The method of claim 13, said catalyzing effect comprising a thermal effect.

15. The method of claim 13, said catalyzing effect comprising an effect of a catalyst chemical agent.

16. The method of claim 13, further comprising mixing said biomass with another material prior to introduction of the mixture of the biomass and the other material into said reactor.
